(19) United States
(12) Patent Application Publication
(10) Pub. No.: US 2009/0037005 A1
(43) Pub. Date: Feb. 5, 2009

(54) Electronic device media management system and method

(76) Inventors: Christopher W. Larsen, Houston, TX (US); Nozomu Yasui, Taipei (TW)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/881,912

(22) Filed: Jul. 30, 2007

(51) Int. Cl. G06F 17/00

(52) U.S. Cl. 700/94

(57) ABSTRACT

An electronic device, comprising a media system module configured to output media content of a playlist, the media system module configured to identify a media file from the playlist and, if the identified media file lacks at least one of an audio component or a visual component, output another media file having the lacking component from the playlist concurrently with the identified media file.

### BACKGROUND

Media players enable a user of an electronic device to compile a media playlist for listing and playing media content. For example, media players enable users to select media content (e.g., photos, music, video, graphics) from multiple sources such as, for example, a local hard drive, a universal plug and play device, a local area network, etc., and compile such selections in a single playlist for playback. However, such devices utilize multiple user interfaces and can be difficult to navigate within and/or utilize, including ordering the output of such playlists.

### BRIEF DESCRIPTION OF THE DRAWINGS

FIG. 1 is a diagram of an electronic device in which an embodiment of a media management system is employed to advantage;

FIG. 2 is a block diagram of the electronic device of FIG. 1; and

FIG. 3 is a flow diagram illustrating a media management method.

### DETAILED DESCRIPTION OF THE DRAWINGS

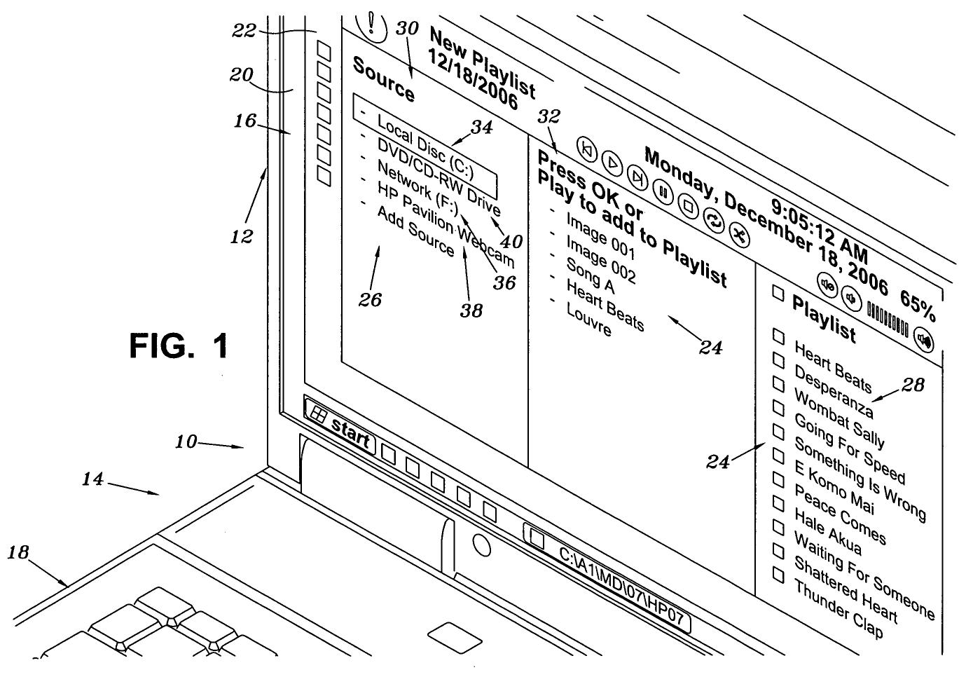

Various embodiments and the advantages thereof are best understood by referring to FIGS. 1-3, like numerals being used for like and corresponding parts of the various drawings.

FIG. 1 is a diagram of an electronic device 10 in which an embodiment of a media management system 12 is employed to advantage. In the embodiment illustrated in FIG. 1, electronic device 10 comprises a laptop or notebook computer 14; however, it should be understood that electronic device 10 may comprise any type of electronic device such as, but not limited to, a tablet personal computer, a personal digital assistant, a desktop computer or any other type of portable or non-portable electronic device. In the embodiment illustrated in FIG. 1, electronic device 10 comprises a display member 16 rotatably coupled to a base member 18.

In the embodiment illustrated in FIG. 1, media management system 12 comprises a media system interface 22 configured to be displayed on a display screen 20 of display member 16 to enable a user of electronic device 10 to select a desired type of media content 24 (e.g., visual files such as picture and video files, and audio files such as music files, etc.) from one or more media sources 26 to facilitate the creation of a playlist 28 (e.g., an index to the selected group of media content 24 on electronic device 10). For example, in the embodiment illustrated in FIG. 1, media system interface 22 comprises a source listing 30 (e.g., a listing of different available media sources 26), a content listing 32 (e.g., a listing of media content 24 for a selected media source 26) and playlist 28. In FIG. 1, source listing 30 enables a user to navigate between different media sources 26 to select a desired media source 26. For example, in the embodiment illustrated in FIG. 1, source listing 30 comprises a local hard drive library/folder 34 corresponding to media files stored on a local hard drive, a local area network library/folder 36 corresponding to media files stored on a local area network or other type of communication network, a universal plug and play device library/folder 38, a DVD/CD-RW device library/folder 40, or any other device/location library/folder having media content therein. It should be understood that a greater or fewer number of library/folders 34, 36, 38 and/or 40 may be listed in source listing 30. In the embodiment illustrated in FIG. 1, media system interface 22 is displayed in a single application (e.g., a single window with separate pane for each of source listing 30, content listing 32 and playlist 28) on display screen 20. In the embodiment illustrated in FIG. 1, interface 22 enables source listing 30 and content listing 32 to change based on user selection while playlist 28 remains unchanged and/or in the current or present view.

In operation, when a particular media source 26 is selected, interface 22 automatically populates content listing 32 with media content 24 from the selected library/folder 34, 36, 38 or 40. For example, in the embodiment illustrated in FIG. 1, when local hard drive library/folder 34 is selected, media stored in the local hard drive is automatically displayed as content listing 32. Accordingly, interface 22 enables a user to select and drag and/or otherwise copy media content 24 in content listing 32 to playlist 28 for inclusion therein. According to some embodiments, interface 22 enables playlist 28 to be populated with files selected from one or more media sources 26. Thus, for example, in the event a user desires to populate playlist 28 with additional file types from other sources (e.g., photos from a DVD/CD-RW device library/folder 40), the user selects another media source 26 to populate content listing 32 with media content 24 associated with a corresponding media source 26. Accordingly, interface 22 enables a user to select and copy additional media content 24 onto playlist 28. It should be understood that media content from any number of source listings 30 may be selected and included in playlist 28.

In the embodiment illustrated in FIG. 1, selected media content 24 is displayed on playlist 28 in the order in which media content 24 is copied or otherwise inserted onto playlist 28. According to some embodiments, the order of media content 24 displayed on playlist 28 may be rearranged by selecting and dragging the particular media content file 28 to the desired position on playlist 28. Likewise, media content 24 listed on playlist 28 may be otherwise removed from playlist 28 by selecting and deleting the desired media content file 24.

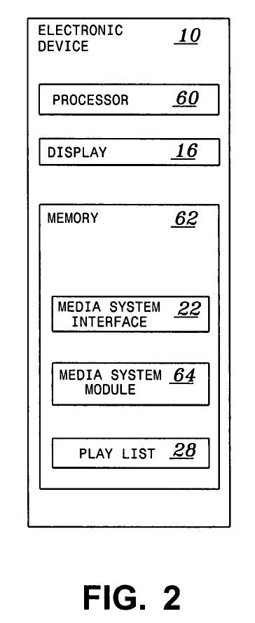

FIG. 2 is a block diagram of electronic device 10 of FIG. 1. In the embodiment illustrated in FIG. 2, electronic device 10 comprises a processor 60, display member 16 and a memory 62. In FIG. 2, memory 62 comprises media system interface 22, a media system module 64, playlist 28 and playlist output data 68. In the embodiment illustrated in FIG. 2, media system interface 22 and media system module 64 may comprise hardware, software, firmware, or a combination thereof and are illustrated as being stored in memory 62 so as to be accessible and/or executable by processor 60. However, it should be understood that media system interface 22 and/or media system module 64 may be otherwise stored, even remotely. In operation, media system module 64 is configured to establish a coordinated and/or otherwise ordered playback of media content 24 for media content listed in playlist 28 (FIG. 1). For example, in the embodiment illustrated in FIG. 2, media system module 64 is configured to read playlist 28 to determine the type(s) of media content 24 listed in playlist 28. In operation, when a user desires to playback the contents in playlist 28, media system module 64 coordinates the playback of files in the playlist such as, music files and picture files, such that picture files and music files play concurrently. Thus for example, during playback, if media system module 64 detects a picture file, media system module 64 will locate a first music file in playlist 28 and coordinate playlist 28 playback with the picture and music files playing concurrently. After a predetermined time, media system module 64 will locate subsequent picture files and display concurrently with the music file. At the completion of playing the music file, media system module 64 will locate a subsequent music files for playback with any successive photo files to provide an ordered and otherwise coordinated playback of media content. Thus, in some embodiments, if a particular media file of playlist 28 is lacking a particular type of content component (e.g., a picture file lay lack an audio component, a music file may lack a visual component, etc.), media system module 64 searches playlist 28 to locate a file to output concurrently with the particular file to supply/output the missing content components. In some embodiments, for example, if the first file identified in playlist 28 to output is a picture file, media system module 64 will locate a music file in playlist 28 to output concurrently with the picture file such that the combined and/or concurrent output contains both an audio component and a video component. It should be understood that picture files may be selected by media system module 64 to output concurrently with picture files also. The concurrent output may be for the duration of the music file, for a duration specified by a user, a predetermined time period, etc.

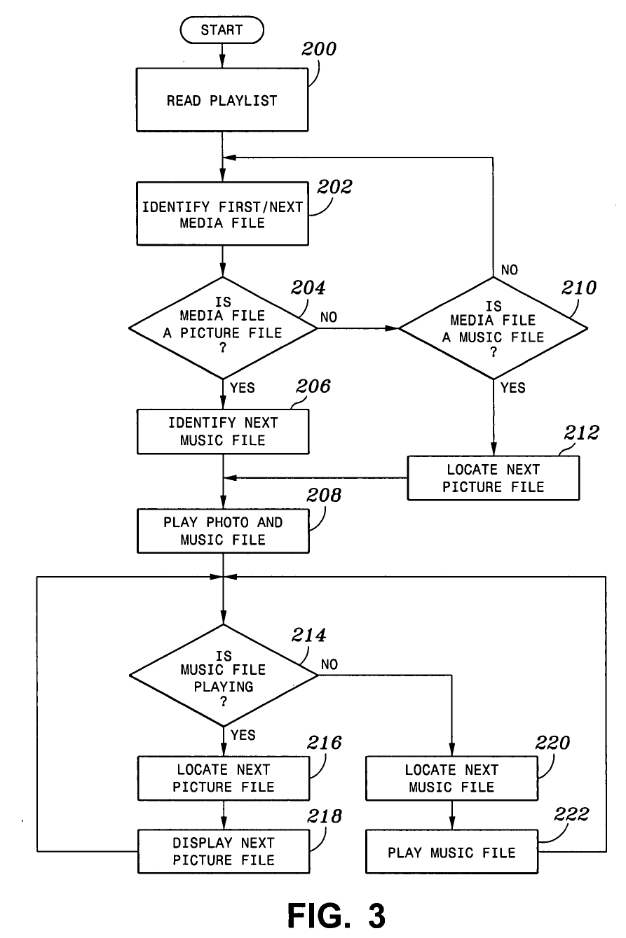

FIG. 3 is a flow diagram illustrating a media management method. In FIG. 3, the method begins at block 200 where media system module 64 reads media content 24 in playlist 28. The method proceeds to block 202 where media system module 64 identifies the first media file of media content 24 listed on playlist 28. At decision block 204, if media system module 64 determines that the located media file is a picture file, the method proceeds to block 206 where media system module 64 locates next music file in playlist 28. Once located, the method proceeds to block 208 where media system module 64 plays and/or otherwise outputs the photo file and music file together. If, at decisional block 204 media system module 64 determines that the media file is not a picture, the method proceeds to decisional block 210 where media system module 64 determines whether or not the media file is a music file. In the event media system module 64 determines that the media file is a music file, the method proceeds to block 212 where media system module 64 locates the next picture file on playlist 28. The method proceeds to block 208 where media system module 64 plays and/or otherwise outputs the photo file and music file together. If at decisional block 210 media file is not a music file, the method returns to block 202 to identify the next type of media file in playlist 28. In the method illustrated in FIG. 3, during playback of playlist 28, media system module 64 is configured to monitor the playback. If at decisional block 214, the music file is determined to still be playing, the method proceeds to block 216 where media system module 64 locates the next picture on playlist 28. The method proceeds to block 218 where media system module 64 displays the next picture in playlist 28 with the current music file. It should be understood that steps 216 and 218 may occur at a predetermined frequency. For example, media system module 64 is be configured such that picture files are displayed for a predetermined time period (e.g., for example, five seconds per picture file). However, it should be understood that any desired frequency may be used to display picture files. If at decisional block 214 the music file is no longer playing, the method proceeds to block 220 so as to enable media system module 64 to locate the next music file on playlist 28. The method proceeds to block 22 where media system module 64 plays the next music file on playlist 28. The method then proceeds back to decisional block 214 until media system module 64 has output all media content 24 in playlist 28.

Thus, embodiments of media management system 12 display and/or otherwise generate an interface 22 executable to display a media source listing 30 comprising a list of media sources 26, a content listing 32 comprising a list of media content 24 for a selected media source 26, and a playlist 28 comprising selected media content 24 from content listing 32, wherein the content listing 32 is automatically updated in response to selecting a media source 26 and playlist 28 is automatically updated in response to selecting media content 24 from the content listing 32. Furthermore, embodiments of media management system 12 output media content 24 of different types together to enabled an ordered and coordinated playback of media content 24 from playlist 28. It should be understood that in the described method, certain functions may be omitted, accomplished in a sequence different from that depicted in FIG. 3, or simultaneously performed. Also, it should be understood that the method depicted in FIG. 3 may be altered to encompass any other features or aspects as described elsewhere in the specification. Furthermore, embodiments may be implemented in software and can be adapted to run on different platforms and operating systems. In particular, functions implemented by interface 22 and media system module 64, for example, may be provided as an ordered listing of executable instructions that can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this document, a computer-readable medium can be any means that can contain, store, communicate, propagate or transport the program for use by or in connection with the instruction execution system, apparatus or device. The computer-readable medium can be, for example but is not limited to, an electronic, magnetic, optical, electro-magnetic, infrared, or semiconductor system, apparatus, device or propagation medium.

What is claimed is:

1. An electronic device, comprising:
a media system module configured to output media content of a playlist, the media system module configured to identify a media file from the playlist and, if the identified media file lacks at least one of an audio component or a visual component, output another media file having the lacking component from the playlist concurrently with the identified media file.

2. The electronic device of claim 1, wherein the media system module is configured to concurrently output a music file in response to determining that the identified media files lacks an audio component.

3. The electronic device of claim 1, wherein the media system module is configured to concurrently output a video file in response to determining that the identified media files lacks a video component.

4. The electronic device of claim 1, wherein in response to determining that the identified media file lacks a visual component, outputting a plurality of photo files for the duration of the media file.

5. A method for outputting media content in a playlist, comprising:
outputting, by a media system module, media content of a playlist, the media system module configured to identify a media file from the playlist and, if the identified media file lacks at least one of an audio component or a visual component, output another media file having the lacking component from the playlist concurrently with the identified media file.

6. The method of claim 5, further comprising concurrently outputting a music file in response to determining that the identified media file lacks an audio component.

7. The method of claim 5, further comprising concurrently outputting a video file in response to determining that the identified media file lacks a video component.

8. The method of claim 5, further comprising outputting a plurality of photo files for the duration of the media in response to determining that the identified media file lacks a visual component.

9. An electronic device, comprising:
a media system module configured to output media content comprising at least one file having an audio content and at least one file having visual content, the media system module configured to identify a first audio file and a first visual file and output the first visual file and first audio file together.

10. The electronic device of claim 9, wherein the audio file comprises a music file.

11. The electronic device of claim 9, wherein the visual file comprises a photo file.

12. The electronic device of claim 9, wherein the media system module is configured to output successive audio files subsequent the first audio file and concurrently output successive visual files after the first visual file.
